(19) United States
(12) Patent Application Publication
(10) Pub. No.: US 2021/0054932 A1
(43) Pub. Date: Feb. 25, 2021

(54) GASKET AND FLOW PASSAGE CONNECTOR STRUCTURE

(71) Applicant: NIPPON PILLAR PACKING CO., LTD., Osaka (JP)

(72) Inventors: Tomoyuki KOIKE, Osaka (JP); Atsushi NAKANO, Osaka (JP); Tomohiro ADACHI, Osaka (JP); Toshihide IIDA, Osaka (JP)

(73) Assignee: NIPPON PILLAR PACKING CO., LTD., Osaka (JP)

(21) Appl. No.: 17/043,172

(22) PCT Filed: Feb. 25, 2019
(86) PCT No.: PCT/JP2019/006975

§ 371 Date: Sep. 29, 2020

(30) Foreign Application Priority Data
Mar. 30, 2018 (JP) 2018-067673
Mar. 30, 2018 (JP) 2018-067942

(51) Int. Cl. F16J 15/08

(52) U.S. Cl. CPC F16J 15/0818

(57) ABSTRACT

A gasket for connecting flow passage holes formed in two piping blocks, respectively, includes, at both sides in an axial direction, a pair of tubular radially outer press-fitting portions configured to be respectively press-fitted into tubular radially outer sealing grooves formed, radially outward of the flow passage holes, on end surfaces of both piping blocks, and a sealing peripheral surface configured to come into close contact with an outer peripheral surface of the radially outer sealing groove to exert a sealing function is formed on an outer peripheral surface of each radially outer press-fitting portion. A groove portion is formed on an outer peripheral surface of the gasket such that, in a state where either one of the pair of radially outer press-fitting portions is press-fitted into a sealing groove of the piping block, the groove portion is open axially outward of the end surface of the piping block.

### TECHNICAL FIELD

The present invention relates to a gasket and a flow passage connector structure.

### BACKGROUND ART

In a piping path for fluids such as chemical solutions, high-purity liquids, ultrapure water, or cleaning solutions that are handled in manufacturing processes in various technical fields such as semiconductor manufacturing, medical/pharmaceutical manufacturing, and food processing/chemical industries, a flow passage connector structure including a gasket for preventing fluid leakage is adopted as a connection structure that connects flow passage holes formed in two fluid devices such as pumps, valves, accumulators, filters, flow meters, pressure sensors, and piping blocks.

### Background Art 1

The gasket of the flow passage connector structure has a pair of cylindrical press-fitting portions at both sides in the axial direction thereof. The gasket functions as a seal for preventing fluid leakage, when these press-fitting portions are press-fitted into cylindrical sealing grooves formed at connection end portions of the flow passage holes of both fluid devices, respectively (see FIG. 14B of PATENT LITERATURE 1).

### Background Art 2

The gasket of the flow passage connector structure has a main body portion, a pair of annular radially inner press-fitting portions that project axially outward from the radially inner sides of both end portions, in the axial direction, of the main body portion, and a pair of cylindrical radially outer press-fitting portions that project axially outward from the radially outer sides of both end portions, in the axial direction, of the main body portion (see FIG. 14B of PATENT LITERATURE 1).

### CITATION LIST

### Patent Literature

PATENT LITERATURE 1: International Publication No. WO2017/176815

### SUMMARY OF INVENTION

### Technical Problem

### Problem 1

Regarding <Background Art 1>, the flow passage connector structure may be disassembled by removing the gasket from both fluid devices, for example, during maintenance work. In this case, after one fluid device is removed from one press-fitting portion of the gasket by pulling the one fluid device axially outward, the one press-fitting portion is held with a jig and pulled axially outward, whereby the other press-fitting portion of the gasket can be removed from the other fluid device. However, when holding the other press-fitting portion with the jig, there is a risk of damaging a sealing peripheral surface formed in the outer peripheral surface of the press-fitting portion.

The present invention has been made in view of <Problem 1> described above, and an object of the present invention is to allow a gasket to be removed from each fluid device without damaging a sealing peripheral surface of the gasket.

### Problem 2

Regarding <Background Art 2>, in the flow passage connector structure, when each fluid device is molded by injection molding, the roundness of a cylindrical radially outer sealing groove decreases due to shrinkage of a molded article in a cooling process of the injection molding, whereby there is a problem that the radially outer press-fitting portion of the gasket cannot be press-fitted into the radially outer sealing groove.

The present invention has been made in view of <Problem 2> described above, and an object of the present invention is to allow a radially outer press-fitting portion of a gasket to be press-fitted into a radially outer sealing groove even when the roundness of the radially outer sealing groove decreases during molding of a fluid device.

### Solution to Problem

(1-1) To solve <Problem 1> described above, a gasket according to the present invention is a gasket including a pair of tubular press-fitting portions provided at both sides in an axial direction, for connecting flow passage holes formed in two fluid devices, respectively, and configured to be respectively press-fitted into tubular sealing grooves formed, radially outward of the flow passage holes, on end surfaces of the fluid devices, wherein a sealing peripheral surface configured to come into close contact with an outer peripheral surface of the sealing groove to exert a sealing function is formed in an outer peripheral surface of each of the press-fitting portions, and a groove portion is formed on an outer peripheral surface of the gasket such that, in a state where either one press-fitting portion of the pair of press-fitting portions is press-fitted into the sealing groove of the fluid device, at least a part of the groove portion is open axially outward of the end surface of the fluid device.

With this gasket, in a state where either one press-fitting portion of the pair of press-fitting portions is press-fitted into the sealing groove of the fluid device, a jig is hooked on the groove portion, which is formed on the outer peripheral surface of the gasket, and is pulled axially outward, whereby the one press-fitting portion of the gasket can be removed from the sealing groove of the fluid device. At this time, the sealing peripheral surface of the outer peripheral surface of the other press-fitting portion is not held with the jig, and thus the sealing peripheral surface can be prevented from being damaged.

(1-2) Preferably, a groove width, in the axial direction, of the groove portion is set within a range of a length in the axial direction between the sealing peripheral surfaces of the pair of press-fitting portions.

In this case, since the groove portion is not formed on the sealing peripheral surface of each press-fitting portion, even when the groove portion is formed on the outer peripheral surface of the gasket, the sealing performance of each press-fitting portion does not deteriorate.

(1-3) Preferably, a groove depth, in a radial direction, of the groove portion is set such that a thickness, in the radial direction, of the gasket at a bottom surface of the groove portion is equal to or greater than a thickness, in the radial direction, of each press-fitting portion.

In this case, the thickness, in the radial direction, of the gasket at the position where the groove portion is formed can be ensured, and thus deterioration of the sealing performance caused by deformation of the gasket at the portion with this thickness can be prevented.

(1-4) Preferably, the groove portion is formed such that an entirety thereof is open between the end surfaces of the fluid devices in a state where the pair of press-fitting portions are press-fitted into the sealing grooves of the fluid devices, respectively.

In this case, even when one press-fitting portion of the gasket is press-fitted into the sealing groove of any one of the fluid devices, the entirety of the groove portion is open on the outer peripheral surface of the gasket, so that the jig can be reliably hooked on the groove portion formed on the outer peripheral surface of the gasket. Therefore, even when one press-fitting portion of the gasket is press-fitted into the sealing groove of any one of the fluid devices, the press-fitting portion of the gasket can be reliably removed from the sealing groove.

(1-5) A flow passage connector structure according to the present invention includes: the gasket in any one of (1-1) to (1-4) described above for connecting flow passage holes formed in two fluid devices, respectively; and a pair of tubular sealing grooves which are formed at connection end portions of the flow passage holes of the fluid devices, respectively, and into which the corresponding press-fitting portions of the gasket are press-fitted.

With this flow passage connector structure, in a state where either one press-fitting portion of the pair of press-fitting portions of the gasket is press-fitted into the sealing groove of the fluid device, a jig is hooked on the groove portion, which is formed on the outer peripheral surface of the gasket, and is pulled axially outward, whereby the one press-fitting portion of the gasket can be removed from the sealing groove of the fluid device. At this time, the sealing peripheral surface of the outer peripheral surface of the other press-fitting portion is not held with the jig, and thus the sealing peripheral surface can be prevented from being damaged.

(2-1) To solve <Problem 2> described above, the gasket according to the present invention is a gasket for connecting flow passage holes formed in two fluid devices, respectively, the gasket including: an annular main body portion; a pair of radially inner press-fitting portions projecting axially outward from radially inner sides of both end portions, in an axial direction, of the main body portion, respectively, and configured to be press-fitted into radially inner sealing grooves formed at connection end portions of the flow passage holes of the fluid devices, respectively; and a pair of cylindrical radially outer press-fitting portions projecting axially outward from radially outer sides of both end portions, in the axial direction, of the main body portion and configured to be respectively press-fitted into cylindrical radially outer sealing grooves formed, radially outward of the flow passage holes, on end surfaces at the connection end portion side of the fluid devices, wherein an annular depression portion is formed on at least a part of an outer peripheral surface of the main body portion.

In this gasket, since the depression portion is formed on the outer peripheral surface of the main body portion which is a thick portion having a largest thickness in the radial direction in the gasket including the radially inner press-fitting portions and the radially outer press-fitting portions, the thickness, in the radial direction, of the main body portion can be decreased by the depression portion. Accordingly, the radially outer press-fitting portions are easily deformed. Therefore, even when the roundness of the radially outer sealing groove decreases during molding of each fluid device, the radially outer press-fitting portion can be press-fitted into the radially outer sealing groove by deforming the radially outer press-fitting portion so as to match the shape of the radially outer sealing groove.

(2-2) Preferably, a part of an outer peripheral surface of each of the radially outer press-fitting portions is formed as a sealing peripheral surface configured to come into close contact with an outer peripheral surface of the radially outer sealing groove to exert a sealing function, and the depression portion is also formed on another part of the outer peripheral surface of each of the radially outer press-fitting portions.

In this case, since the depression portion is formed on the outer peripheral surface of each radially outer press-fitting portion, the thickness, in the radial direction, of each radially outer press-fitting portion is decreased, and thus each radially outer press-fitting portion is easier to deform. In addition, since the depression portion is formed on the other part, excluding the sealing peripheral surface, of the outer peripheral surface of each radially outer press-fitting portion, even when the depression portion is formed on each radially outer press-fitting portion, the sealing performance of each radially outer press-fitting portion does not deteriorate.

(2-3) Preferably, the depression portion is formed by a concave curved surface.

In this case, the thickness, in the radial direction, of the main body portion can be gradually decreased. Thus, stress applied to the outer peripheral surface of the main body portion when the radially outer press-fitting portion is deformed can be distributed by the depression portion.

(2-4) The flow passage connector structure according to the present invention includes: the gasket in any one of (2-1) to (2-3) described above for connecting flow passage holes formed in two fluid devices, respectively; a pair of radially inner sealing grooves which are formed at connection end portions of the flow passage holes of the fluid devices, respectively, and into which the respective radially inner press-fitting portions of the gasket are press-fitted; and a pair of cylindrical radially outer sealing grooves which are formed, radially outward of the flow passage holes, on end surfaces at the connection end portion side of the fluid devices, respectively, and into which the respective radially outer press-fitting portions of the gasket are press-fitted.

In this flow passage connector structure, since the depression portion is formed on the outer peripheral surface of the main body portion which is a thick portion having a largest thickness in the radial direction in the gasket including the radially inner press-fitting portions and the radially outer press-fitting portions, the thickness, in the radial direction, of the main body portion can be decreased by the depression portion. Accordingly, the cylindrical radially outer press-fitting portions are easily deformed. Therefore, even when the roundness of the radially outer sealing groove decreases during molding of each fluid device, the radially outer press-fitting portion can be press-fitted into the radially outer sealing groove by deforming the radially outer press-fitting portion so as to match the shape of the radially outer sealing groove.

### Advantageous Effects of Invention

According to the present invention made in view of <Problem 1> described above, the gasket can be removed from each fluid device without damaging the sealing peripheral surface of the gasket.

According to the present invention made in view of <Problem 2> described above, even when the roundness of the radially outer sealing groove decreases during molding of each fluid device, the radially outer press-fitting portion of the gasket can be press-fitted into the radially outer sealing groove.

### BRIEF DESCRIPTION OF DRAWINGS

FIG. 1 is a cross-sectional perspective view showing an example of flow passage connector structures according to an embodiment of the present invention in Chapter 1 and an embodiment of the present invention in Chapter 2.

FIG. 2 is an enlarged cross-sectional view of a flow passage connector structure in Chapter 1.

FIG. 3 is an exploded enlarged cross-sectional view of the flow passage connector structure in Chapter 1.

FIG. 4 is an enlarged cross-sectional view showing a state where the flow passage connector structure in Chapter 1 is being disassembled.

FIG. 5 is an enlarged cross-sectional view showing a state where the flow passage connector structure in Chapter 1 is being disassembled.

FIG. 6 is an enlarged cross-sectional view of a flow passage connector structure showing a modification of a groove portion in Chapter 1.

FIG. 7 is an enlarged cross-sectional view of a flow passage connector structure showing another modification of the groove portion in Chapter 1.

FIG. 8 is an enlarged cross-sectional view of a flow passage connector structure in Chapter 2.

FIG. 9 is an exploded enlarged cross-sectional view of the flow passage connector structure in Chapter 2.

FIG. 10 is an exploded enlarged cross-sectional view of a flow passage connector structure showing a modification of a depression portion in Chapter 2.

### DESCRIPTION OF EMBODIMENTS

### <Chapter 1>

Next, preferred embodiments of the present invention in Chapter 1 will be described with reference to the accompanying drawings.

### [Flow Passage Connector Structure]

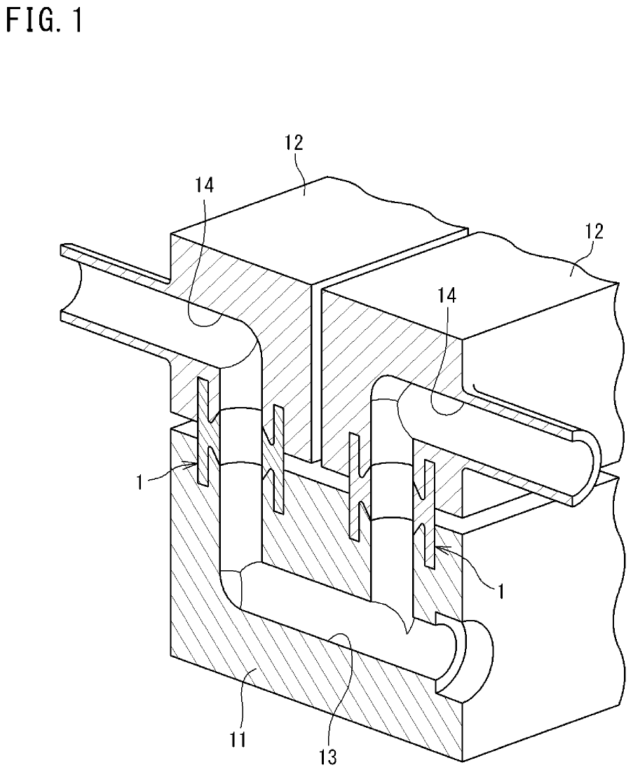

FIG. 1 is a cross-sectional perspective view showing an example of a flow passage connector structure according to an embodiment of the present invention in Chapter 1. In FIG. 1, a flow passage connector structure 1 according to the present embodiment is used, for example, as a connection structure that connects flow passage holes 13 and 14 formed in two piping blocks (fluid devices) 11 and 12 stacked on each other, in a piping path through which a chemical solution used in a semiconductor manufacturing apparatus flows.

In the example of FIG. 1, when forming the piping path by stacking a plurality of small second piping blocks 12, 12, each of which is to be connected to a flow meter, a pressure sensor, or the like, on a large first piping block 11 composed of a base block, a circular flow passage hole 13 that is open at two locations in the upper surface of the first piping block 11 and circular flow passage holes 14, 14 that are open in the lower surfaces of the respective second piping blocks 12, 12 are connected by using the flow passage connector structure 1. In the present embodiment, the flow passage hole 13 of the first piping block 11 and the flow passage holes 14, 14 of the second piping blocks 12, 12 are formed with the same diameter.

The flow passage connector structure 1 according to the present embodiment is used as the connection structure that connects the flow passage holes 13 and 14 of the piping blocks 11 and 12, but can also be applied to a connection structure that connects flow passage holes of other fluid devices such as pumps, valves, accumulators, and filters.

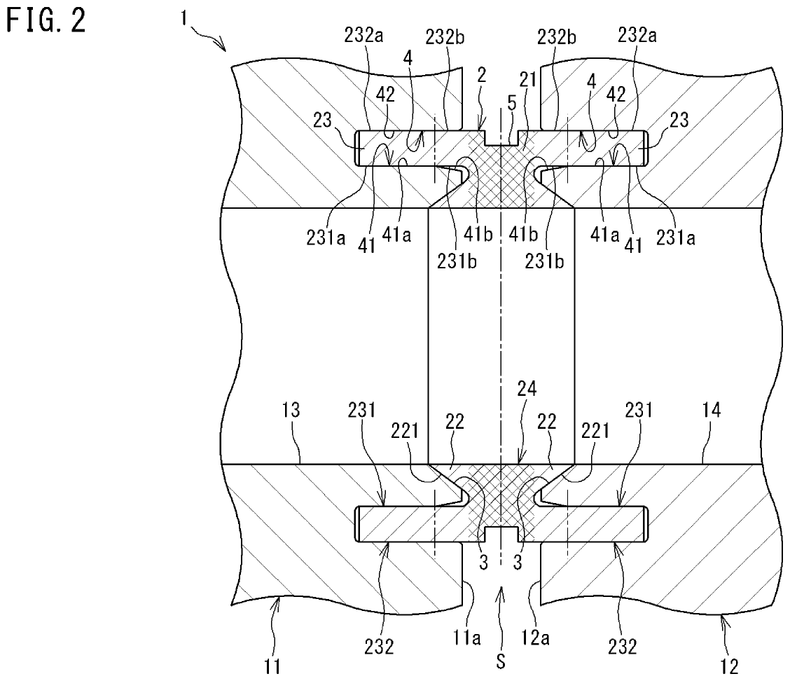

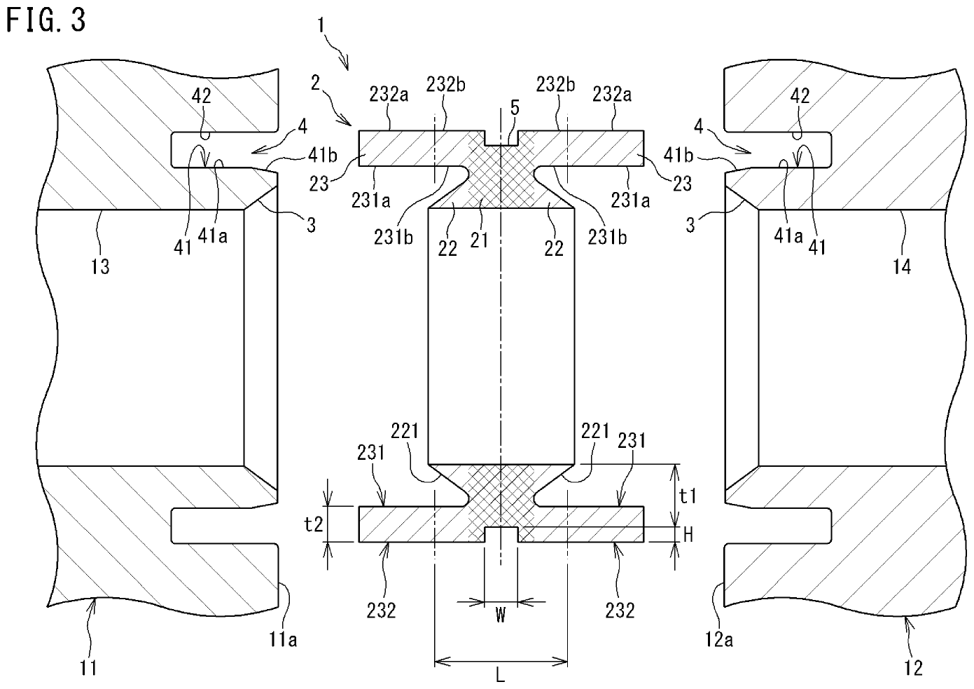

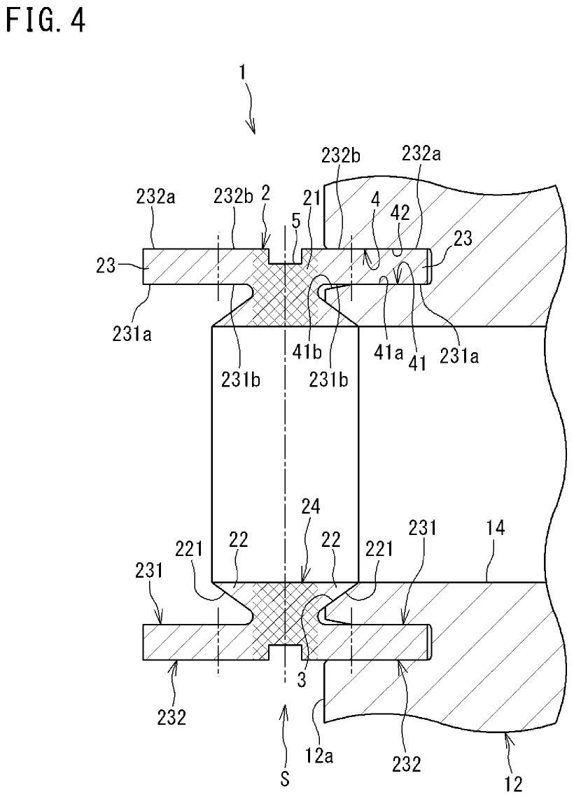

FIG. 2 is an enlarged cross-sectional view of the flow passage connector structure 1. FIG. 3 is an exploded enlarged cross-sectional view of the flow passage connector structure 1. In FIG. 2 and FIG. 3, for convenience of description, the piping blocks 11 and 12 are arranged sideways (the same applies to FIG. 4 to FIG. 7).

In FIG. 2 and FIG. 3, the flow passage connector structure 1 includes: a gasket 2 for connecting the flow passage holes 13 and 14 of the two piping blocks 11 and 12; radially inner sealing grooves 3 formed at connection end portions of the flow passage holes 13 and 14 of both piping blocks 11 and 12, respectively; and radially outer sealing grooves (sealing grooves) 4 formed, radially outward of the flow passage holes 13 and 14, on end surfaces 11a and 12a at the connection end portion side of both piping blocks 11 and 12, respectively.

### [Radially Inner Sealing Grooves and Radially Outer Sealing Grooves]

In FIG. 3, the radially inner sealing groove 3 of the first piping block 11 is formed on the peripheral surface of the connection end portion of the flow passage hole 13 as a tapered groove that is cut out so as to have a diameter gradually increasing from the inner side in the axial direction toward the outer end thereof in the axial direction. Similarly, the radially inner sealing groove 3 of the second piping block 12 is formed on the peripheral surface of the connection end portion of the flow passage hole 14 as a tapered groove that is cut out so as to have a diameter gradually increasing from the inner side in the axial direction toward the outer end thereof in the axial direction.

The radially outer sealing grooves 4 of the first piping block 11 and the second piping block 12 are each formed in a cylindrical shape. An inner peripheral surface 41 of each radially outer sealing groove 4 has a circumferential surface 41a extending straight in the axial direction, and a tapered guide peripheral surface 41b formed axially outward of the circumferential surface 41a, in a cross-sectional view.

The inner end, in the axial direction, of the guide peripheral surface 41b is connected to the outer end, in the axial direction, of the circumferential surface 41a. The guide peripheral surface 41b is formed so as to have a diameter gradually increasing from the inner end thereof in the axial direction toward the outer end thereof in the axial direction (from the circumferential surface 41a toward the later-described gasket 2 side in FIG. 3). Accordingly, when press-fitting a radially outer press-fitting portion 23 of the gasket 2 into the radially outer sealing groove 4, the guide peripheral surface 41b serves to guide the press-fitting.

The entirety of an outer peripheral surface 42 of each radially outer sealing groove 4 is formed as a circumferential surface extending straight in the axial direction in a cross-sectional view. It is sufficient that the flow passage connector structure 1 includes at least the pair of radially outer sealing grooves 4, among the pair of radially inner sealing grooves 3 and the pair of radially outer sealing grooves 4 (except for a flow passage connector structure 1 in Chapter 2 described later).

### [Gasket]

In FIG. 2 and FIG. 3, the gasket 2 includes: a main body portion 21 (portion shown by cross hatching in the drawing); a pair of radially inner press-fitting portions 22 press-fitted into the radially inner sealing grooves 3 of the first and second piping blocks 11 and 12, respectively; and a pair of radially outer press-fitting portions (press-fitting portions) 23 press-fitted into the radially outer sealing grooves 4 of the first and second piping blocks 11 and 12, respectively. It is sufficient that the gasket 2 includes at least the pair of radially outer press-fitting portions 23, among the pair of radially inner press-fitting portions 22 and the pair of radially outer press-fitting portions 23.

The main body portion 21 is formed in an annular shape at a center portion, in the axial direction, of the gasket 2, and is formed as a thick portion in which the thickness in the radial direction (up-down direction in the drawing) of the gasket 2 is large. In the state shown in FIG. 2, the main body portion 21 is disposed between the end surfaces 11a and 12a of both piping blocks 11 and 12, and a gap S is formed, radially outward of the main body portion 21, between both end surfaces 11a and 12a.

The pair of radially inner press-fitting portions 22 are portions having a triangular shape in a cross-sectional view and formed in an annular shape so as to project axially outward from the radially inner sides of both end portions, in the axial direction, of the main body portion 21.

The inner peripheral surface of each radially inner press-fitting portion 22 is formed with a diameter that is substantially equal to that of the inner peripheral surface of the main body portion 21 and that is substantially equal to those of the flow passage holes 13 and 14.

Therefore, the inner peripheral surface of the main body portion 21, the inner peripheral surfaces of the pair of radially inner press-fitting portions 22, and the peripheral surfaces of the flow passage holes 13 and 14 are formed so as to be substantially flush with each other in a cross-sectional view. Accordingly, a connection flow passage 24 having a circular shape as viewed in the axial direction and connecting the flow passage holes 13 and 14 is formed inside the main body portion 21 and the pair of radially inner press-fitting portions 22. As described above, no step is formed on the flow passage holes 13 and 14 and the inner peripheral surface of the gasket 2, and thus a fluid flowing in the flow passage holes 13 and 14 can be prevented from staying therein.

The outer peripheral surface of each radially inner press-fitting portion 22 is formed as a tapered peripheral surface 221 having a diameter gradually increasing from the outer end thereof in the axial direction toward the inner end thereof in the axial direction. The tapered peripheral surfaces 221 of the pair of radially inner press-fitting portions 22 are formed as sealing peripheral surfaces that come into close contact with the peripheral surfaces of the radially inner sealing grooves 3 of the first and second piping blocks 11 and 12 to exert a sealing function. Accordingly, when being press-fitted into the radially inner sealing grooves 3 of the first and second piping blocks 11 and 12, the pair of radially inner press-fitting portions 22 of the gasket 2 function as seals (primary seals) closest to the flow passage holes 13 and 14 and prevent the fluid in the flow passage holes 13 and 14 from leaking to the outside.

The pair of radially outer press-fitting portions 23 are formed in a cylindrical shape so as to project axially outward from the radially outer sides of both end portions, in the axial direction, of the main body portion 21. The outer peripheral surface of each radially outer press-fitting portion 23 is formed with a diameter substantially equal to that of the outer peripheral surface of the main body portion 21, and also formed so as to be substantially flush with the outer peripheral surface of the main body portion 21. Accordingly, in the present embodiment, the outer peripheral surfaces of the pair of radially outer press-fitting portions 23 and the outer peripheral surface of the main body portion 21 are formed as the outer peripheral surface of the gasket 2. The length, in the axial direction, of each radially outer press-fitting portion 23 is set so as to be slightly shorter than the length (groove depth), in the axial direction, of the corresponding radially outer sealing groove 4.

A portion (portion axially outward of a virtual line shown by an alternate long and two short dashes line in the drawing) of an inner peripheral surface 231 of each radially outer press-fitting portion 23 is formed as a sealing peripheral surface 231a that comes into close contact with the circumferential surface 41a of the corresponding radially outer sealing groove 4 to exert a sealing function. Another portion (portion axially inward of the virtual line shown by the alternate long and two short dashes line in the drawing) of the inner peripheral surface 231 of each radially outer press-fitting portion 23 is formed as a non-sealing peripheral surface 231b that opposes the guide peripheral surface 41b of the corresponding radially outer sealing groove 4 with a predetermined gap therebetween and exerts almost no sealing function. The virtual line shown by the alternate long and two short dashes line is a virtual line extending in the radial direction of the gasket 2 so as to pass through the boundary between the circumferential surface 41a and the guide peripheral surface 41b of the inner peripheral surface 41 of each radially outer sealing groove 4 (see FIG. 2).

A portion (portion axially outward of the virtual line shown by the alternate long and two short dashes line in the drawing) of an outer peripheral surface 232 of each radially outer press-fitting portion 23 is formed as a sealing peripheral surface 232a that comes into close contact with the outer peripheral surface 42 of the corresponding radially outer sealing groove 4 to exert a sealing function. Another portion (portion axially inward of the virtual line shown by the alternate long and two short dashes line in the drawing) of the outer peripheral surface 232 of each radially outer press-fitting portion 23 is formed as a non-sealing peripheral surface 232b that exerts almost no sealing function. Accordingly, when being press-fitted into the radially outer sealing grooves 4 of the first and second piping blocks 11 and 12, the pair of radially outer press-fitting portions 23 of the gasket 2 function as secondary seals that prevent the fluid in the flow passage holes 13 and 14 from leaking to the outside.

Although each radially outer press-fitting portion 23 according to the present embodiment is formed in a cylindrical shape, each radially outer press-fitting portion 23 may be formed in a polygonal tube shape. In this case, each radially outer sealing groove 4 may be formed in a polygonal tube shape in accordance with the shape of each radially outer press-fitting portion 23.

### [Procedure for Disassembling Flow Passage Connector Structure]

The flow passage connector structure 1 according to the present embodiment is disassembled as shown in FIG. 3 by removing the gasket 2 from both piping blocks 11 and 12 from the state shown in FIG. 2, for example, during maintenance work. The following two procedures are conceivable as a procedure for disassembling the flow passage connector structure 1.

In the first disassembling procedure, the first piping block 11 is pulled axially outward from the state shown in FIG. 2 to be removed from one press-fitting portion 22 and one press-fitting portion 23 (at the left side in the drawing) of the gasket 2 to obtain the state shown in FIG. 4. Then, the one press-fitting portion 22 and the one press-fitting portion 23 are pulled axially outward (leftward in the drawing) from the state shown in FIG. 4, thereby removing the other press-fitting portions 22 and 23 (at the right side in the drawing) of the gasket 2 from the second piping block 12.

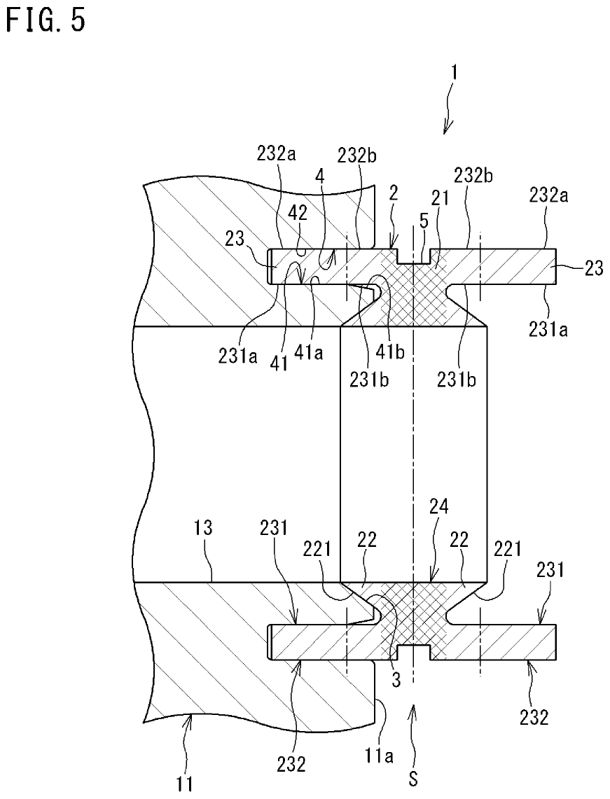

In the second disassembling procedure, the second piping block 12 is pulled axially outward from the state shown in FIG. 2 to be removed from one press-fitting portion 22 and one press-fitting portion 23 (at the right side in the drawing) of the gasket 2 to obtain the state shown in FIG. 5. Then, the one press-fitting portion 22 and the one press-fitting portion 23 are pulled axially outward (rightward in the drawing) from the state shown in FIG. 5, thereby removing the other press-fitting portions 22 and 23 (at the left side in the drawing) of the gasket 2 from the first piping block 11.

### [Groove Portion]

An annular groove portion 5 for hooking a jig on the gasket 2 in a state where the flow passage connector structure 1 is being disassembled as shown in FIG. 4 or FIG. 5 is formed on the outer peripheral surface of the gasket 2.

The groove portion 5 according to the present embodiment is formed in an angular-recess cross-sectional shape on the outer peripheral surface of the main body portion 21 of the gasket 2. In addition, the groove portion 5 according to the present embodiment is formed such that the entirety thereof is open radially outward in the gap S between the end surfaces 11a and 12a of both piping blocks 11 and 12 in the state shown in FIG. 2, that is, in a state where the pair of radially inner press-fitting portions 22 and the pair of radially outer press-fitting portions 23 of the gasket 2 are press-fitted into the radially inner sealing grooves 3 and the radially outer sealing grooves 4 of both piping blocks 11 and 12.

Accordingly, in the present embodiment, even in either a state where only one press-fitting portion 22 and one press-fitting portion 23 (at one side in the axial direction) of the gasket 2 are press-fitted into the sealing grooves 3 and 4 of the second piping block 12 (see FIG. 4) or a state where only the other press-fitting portions 22 and 23 (at the other side in the axial direction) of the gasket 2 are press-fitted into the sealing grooves 3 and 4 of the first piping block 11 (see FIG. 5), the entirety of the groove portion 5 is open radially outward, so that the jig can be reliably hooked on the groove portion 5.

It is sufficient that the groove portion 5 is formed such that, in either one of the states shown in FIG. 4 and FIG. 5, at least a part of the groove portion 5 is open axially outward of the end surface of the piping block into which the press-fitting portions 22 and 23 of the gasket 2 are press-fitted.

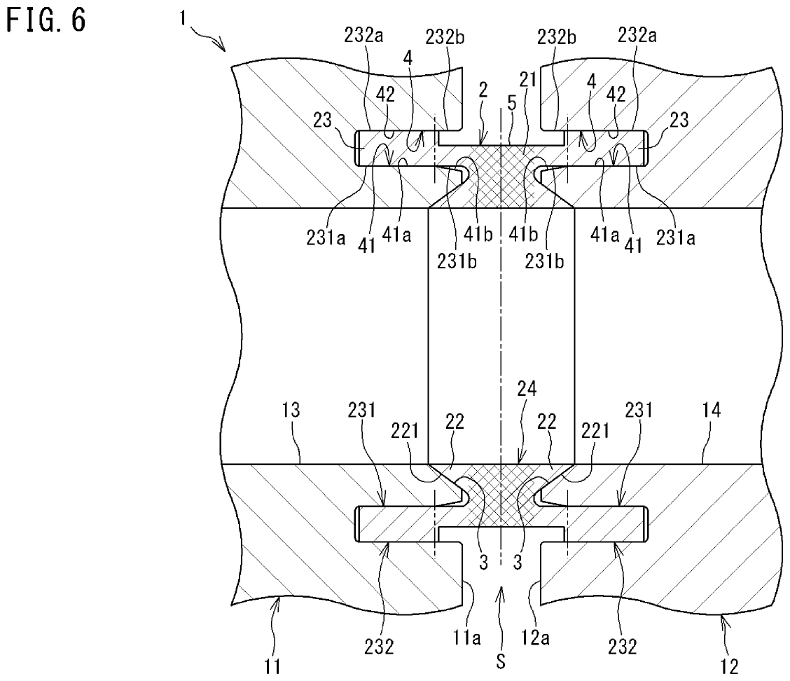

It is sufficient that, in FIG. 3, a groove width W, in the axial direction, of the groove portion 5 is set within the range of a length L in the axial direction between the sealing peripheral surfaces 232a of the pair of radially outer press-fitting portions 23 (between two virtual lines shown by alternate long and two short dashes lines in the drawing). Therefore, as long as the groove width W is set as described above, the groove portion 5 may be formed on not only the outer peripheral surface of the main body portion 21 but also the outer peripheral surface, at the inner side in the axial direction, of the radially outer press-fitting portion 23 so as to be longer at the outer side in the axial direction than the end surfaces 11a and 12a of the respective piping blocks 11 and 12 as in a modification shown in FIG. 6.

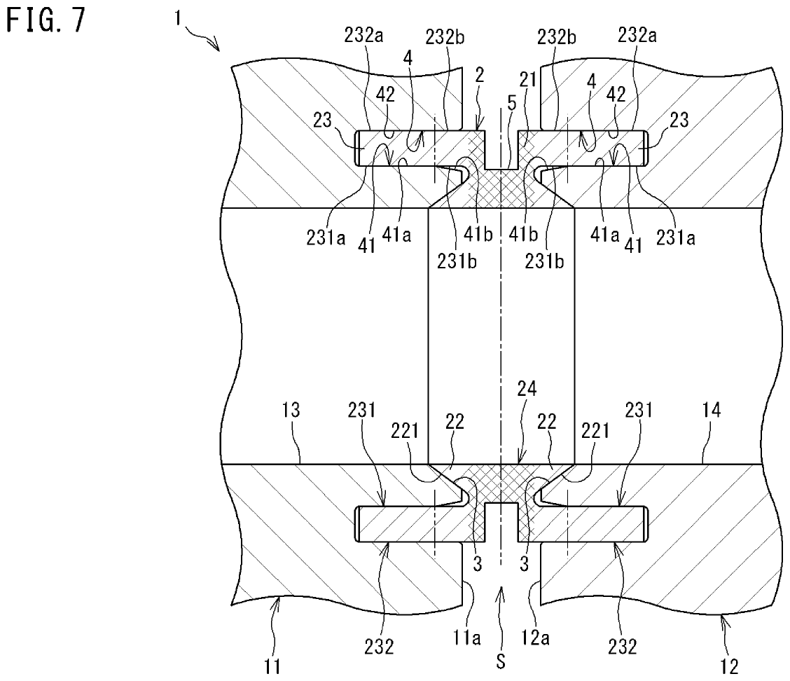

Moreover, in FIG. 3, as in the present embodiment, when the main body portion 21 is formed with a large thickness in the radial direction since the radially inner press-fitting portions 22 and the radially outer press-fitting portions 23 are formed at the main body portion 21 of the gasket 2, it is sufficient that a groove depth H, in the radial direction, of the groove portion 5 is set such that a thickness t1, in the radial direction, of the main body portion 21 at the bottom surface of the groove portion 5 is equal to or greater than a thickness t2, in the radial direction, of each radially outer press-fitting portion 23. Therefore, as long as the groove depth H is set as described above, the groove portion 5 may be formed so as to be deeper at the inner side in the radial direction than in FIG. 3, as in a modification shown in FIG. 7.

The groove portion 5 may be formed in another cross-sectional shape such as an arc cross-sectional shape instead of an angular-recess cross-sectional shape, as long as the jig can be hooked on the groove portion 5. In addition, although the groove portion 5 according to the present embodiment is formed in an annular shape, the groove portion 5 may be formed at one location or a plurality of locations in the circumferential direction. Moreover, the groove portion 5 may be formed at a plurality of locations in the axial direction on the outer peripheral surface of the gasket 2.

### Advantageous Effects

As described above, in the flow passage connector structure 1 according to the present embodiment, in a state where either one press-fitting portion 22 and either one press-fitting portion 23 of the gasket 2 are press-fitted into the sealing grooves 3 and 4 of one piping block 11 (12), the jig is hooked on the groove portion 5, which is formed on the outer peripheral surface of the gasket 2, and is pulled axially outward, whereby the one press-fitting portion 22 and the one press-fitting portion 23 of the gasket 2 can be removed from the sealing grooves 3 and 4 of the one piping block 11 (12). At this time, the sealing peripheral surfaces 232a of the outer peripheral surfaces of the other press-fitting portions 22 and 23 are not held with the jig. Thus, the sealing peripheral surfaces 232a can be prevented from being damaged.

Moreover, since the groove width W, in the axial direction, of the groove portion 5 is set within the range of the length L in the axial direction between the sealing peripheral surfaces 232a of the pair of radially outer press-fitting portion 23, the groove portion 5 is not formed on the sealing peripheral surface 232a of each radially outer press-fitting portion 23. Accordingly, even when the groove portion 5 is formed on the outer peripheral surface of the gasket 2, the sealing performance of each radially outer press-fitting portion 23 does not deteriorate.

Moreover, the groove depth H, in the radial direction, of the groove portion 5 is set such that the thickness t1, in the radial direction, of the gasket 2 (main body portion 21) at the bottom surface of the groove portion 5 is equal to or greater than the thickness t2, in the radial direction, of each press-fitting portion. Accordingly, the thickness t1, in the radial direction, of the gasket 2 at the position where the groove portion 5 is formed can be ensured, and thus deterioration of the sealing performance caused by deformation of the gasket 2 at the portion with the thickness t1 can be prevented.

Moreover, the groove portion 5 is formed such that the entirety thereof is open between the end surfaces 11a and 12a of both piping blocks 11 and 12 in a state where the pair of radially inner press-fitting portions 22 and the pair of radially outer press-fitting portions 23 are press-fitted into the radially inner sealing grooves 3 and the radially outer sealing grooves 4 of both piping blocks 11 and 12. Accordingly, even when one press-fitting portion 22 and one press-fitting portion 23 of the gasket 2 are press-fitted into the sealing grooves 3 and 4 of any one of both piping blocks 11 and 12, the entirety of the groove portion 5 is open radially outward on the outer peripheral surface of the gasket 2, so that the jig can be reliably hooked on the groove portion 5 of the gasket 2. Therefore, even when one press-fitting portion 22 and one press-fitting portion 23 of the gasket 2 are press-fitted into the sealing grooves 3 and 4 of any one of both piping blocks 11 and 12, the press-fitting portions 22 and 23 of the gasket 2 can be reliably removed from the sealing grooves 3 and 4.

The embodiments disclosed in Chapter 1 are merely illustrative in all aspects and should be considered not restrictive. The scope of the present invention is defined by the scope of the claims rather than the meaning described above, and is intended to include meaning equivalent to the scope of the claims and all modifications within the scope.

For example, although the flow passage connector structure 1 used in the semiconductor field has been described as an example in the above embodiment, the field is not limited thereto, and the integrated block 1 may be used in the liquid crystal/organic EL field, the medical/pharmaceutical field, or the automotive field.

### REFERENCE SIGNS LIST

1 flow passage connector structure
2 gasket
4 radially outer sealing groove (sealing groove)
5 groove portion
11 first piping block (fluid device)
11a end surface
12 second piping block (fluid device)
12a end surface
13 flow passage hole
14 flow passage hole
23 radially outer press-fitting portion (press-fitting portion)
232 outer peripheral surface of radially outer press-fitting portion
232a sealing peripheral surface
H groove depth
t1 thickness, in radial direction, of gasket
t2 thickness, in radial direction, of radially outer press-fitting portion
W groove width

### <Chapter 2>

Next, preferred embodiments of the present invention in Chapter 2 will be described with reference to the accompanying drawings.

### [Flow Passage Connector Structure]

FIG. 1 is a cross-sectional perspective view showing an example of a flow passage connector structure according to an embodiment of the present invention in Chapter 2. A flow passage connector structure 1 in Chapter 2 has the same components as those in the flow passage connector structure 1 described in Chapter 1, thus these components are designated by the same reference signs, and the description thereof is omitted.

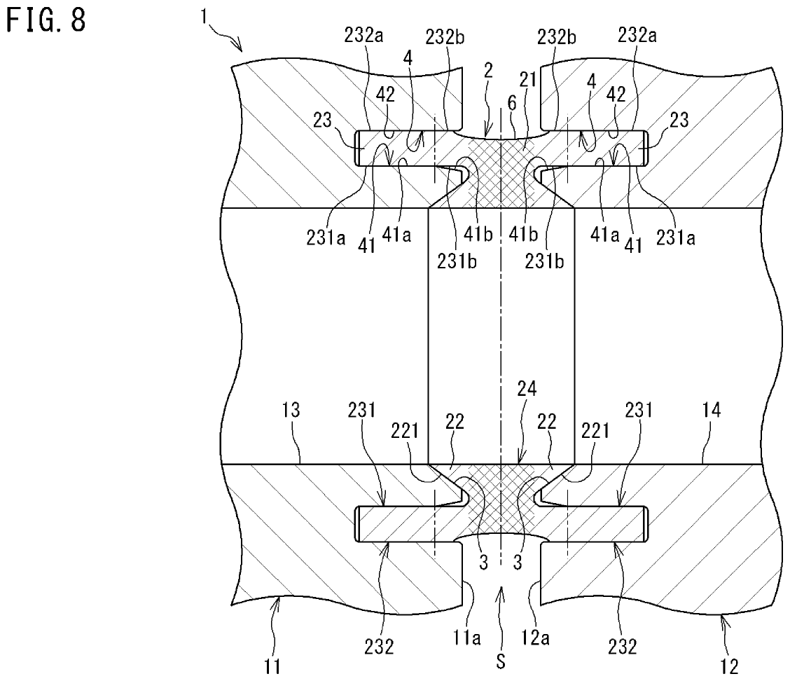

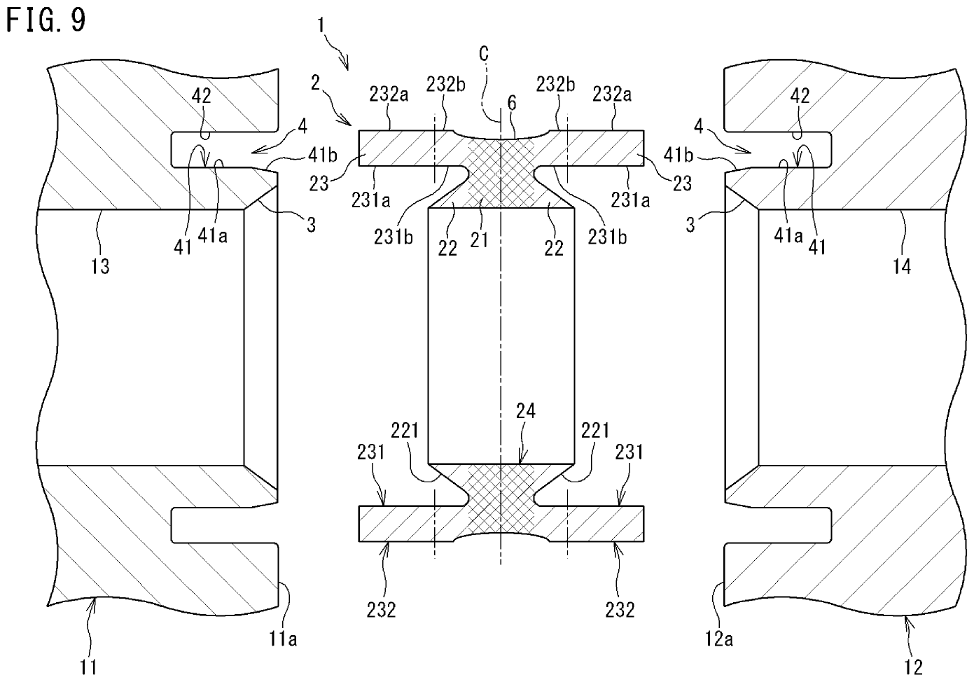

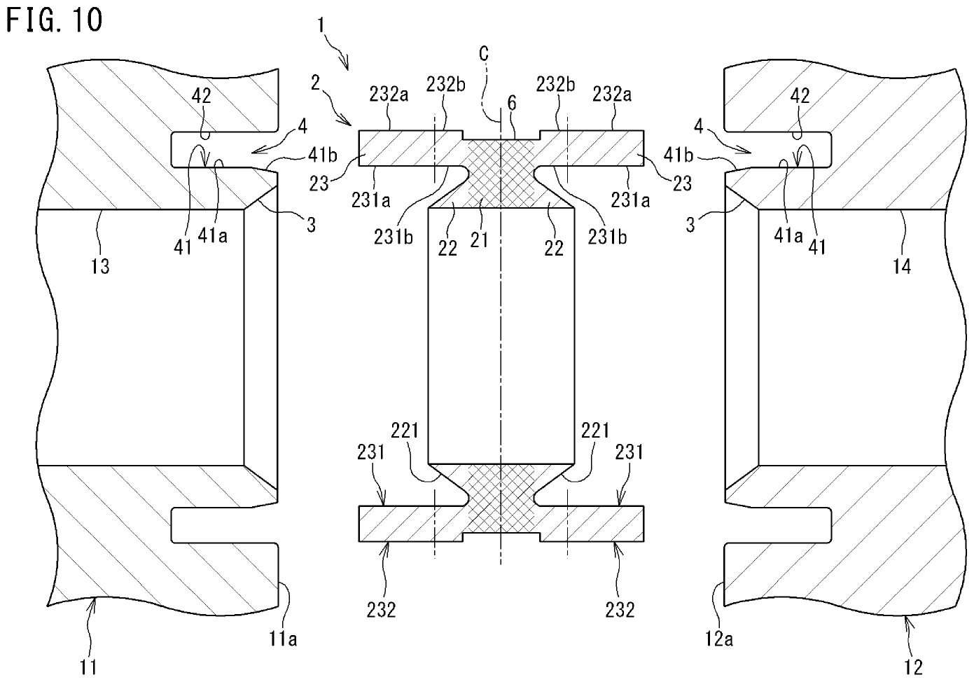

FIG. 8 is an enlarged cross-sectional view of the flow passage connector structure 1 in Chapter 2. FIG. 9 is an exploded enlarged cross-sectional view of the flow passage connector structure 1 in Chapter 2. In FIG. 8 and FIG. 9, for convenience of description, the piping blocks 11 and 12 are arranged sideways (the same applies to FIG. 10).

In FIG. 8 and FIG. 9, the flow passage connector structure 1 includes: a gasket 2 for connecting the flow passage holes 13 and 14 of the two piping blocks 11 and 12; radially inner sealing grooves 3 formed at connection end portions of the flow passage holes 13 and 14 of both piping blocks 11 and 12, respectively; and radially outer sealing grooves 4 formed, radially outward of the flow passage holes 13 and 14, on end surfaces 11a and 12a at the connection end portion side of both piping blocks 11 and 12, respectively.

### [Radially Inner Sealing Grooves and Radially Outer Sealing Grooves]

The radially inner sealing grooves 3 of the first piping block 11 and the second piping block 12 in Chapter 2 have the same components as those of the radially inner sealing grooves 3 of the first piping block 11 and the second piping block 12 in Chapter 1, thus, these portions are designated by the same reference signs, and the description thereof is omitted.

Moreover, the radially outer sealing grooves 4 of the first piping block 11 and the second piping block 12 in Chapter 2 have the same components as those of the radially outer sealing grooves 4 of the first piping block 11 and the second piping block 12 in Chapter 1, thus, these portions are designated by the same reference signs, and the description thereof is omitted.

### [Gasket]

In FIG. 8 and FIG. 9, the gasket 2 includes: a main body portion 21 (portion shown by cross hatching in the drawing); a pair of radially inner press-fitting portions 22 press-fitted into the radially inner sealing grooves 3 of the first and second piping blocks 11 and 12, respectively; and a pair of radially outer press-fitting portions 23 press-fitted into the radially outer sealing grooves 4 of the first and second piping blocks 11 and 12, respectively.

The main body portion 21 is formed in an annular shape at a center portion, in the axial direction, of the gasket 2, and is formed as a thick portion in which the thickness in the radial direction (up-down direction in the drawing) of the gasket 2 is large. In the state shown in FIG. 8, the main body portion 21 is disposed between the end surfaces 11a and 12a of both piping blocks 11 and 12, and a gap S is formed, radially outward of the main body portion 21, between both end surfaces 11a and 12a.

The pair of radially inner press-fitting portions 22 are portions having a triangular shape in a cross-sectional view and formed in an annular shape so as to project axially outward from the radially inner sides of both end portions, in the axial direction, of the main body portion 21.

The inner peripheral surface of each radially inner press-fitting portion 22 is formed with a diameter that is substantially equal to that of the inner peripheral surface of the main body portion 21 and that is substantially equal to those of the flow passage holes 13 and 14.

Therefore, the inner peripheral surface of the main body portion 21, the inner peripheral surfaces of the pair of radially inner press-fitting portions 22, and the peripheral surfaces of the flow passage holes 13 and 14 are formed so as to be substantially flush with each other in a cross-sectional view. Accordingly, a connection flow passage 24 having a circular shape as viewed in the axial direction and connecting the flow passage holes 13 and 14 is formed inside the main body portion 21 and the pair of radially inner press-fitting portions 22. As described above, no step is formed on the flow passage holes 13 and 14 and the inner peripheral surface of the gasket 2, and thus a fluid flowing in the flow passage holes 13 and 14 can be prevented from staying therein.

The outer peripheral surface of each radially inner press-fitting portion 22 is formed as a tapered peripheral surface 221 having a diameter gradually increasing from the outer end thereof in the axial direction toward the inner end thereof in the axial direction. The tapered peripheral surfaces 221 of the pair of radially inner press-fitting portions 22 are formed as sealing peripheral surfaces that come into close contact with the peripheral surfaces of the radially inner sealing grooves 3 of the first and second piping blocks 11 and 12 to exert a sealing function. Accordingly, when being press-fitted into the radially inner sealing grooves 3 of the first and second piping blocks 11 and 12, the pair of radially inner press-fitting portions 22 of the gasket 2 function as seals (primary seals) closest to the flow passage holes 13 and 14 and prevent the fluid in the flow passage holes 13 and 14 from leaking to the outside.

The pair of radially outer press-fitting portions 23 are formed in a cylindrical shape so as to project axially outward from the radially outer sides of both end portions, in the axial direction, of the main body portion 21. The length, in the axial direction, of each radially outer press-fitting portion 23 is set so as to be slightly shorter than the length (groove depth), in the axial direction, of the corresponding radially outer sealing groove 4.

A portion (portion axially outward of a virtual line shown by an alternate long and two short dashes line in the drawing) of an inner peripheral surface 231 of each radially outer press-fitting portion 23 is formed as a sealing peripheral surface 231a that comes into close contact with the circumferential surface 41a of the corresponding radially outer sealing groove 4 to exert a sealing function. Another portion (portion axially inward of the virtual line shown by the alternate long and two short dashes line in the drawing) of the inner peripheral surface 231 of each radially outer press-fitting portion 23 is formed as a non-sealing peripheral surface 231b that opposes the guide peripheral surface 41b of the corresponding radially outer sealing groove 4 with a predetermined gap therebetween and exerts almost no sealing function. The virtual line shown by the alternate long and two short dashes line is a virtual line extending in the radial direction of the gasket 2 so as to pass through the boundary between the circumferential surface 41a and the guide peripheral surface 41b of the inner peripheral surface 41 of each radially outer sealing groove 4 (see FIG. 8).

A portion (portion axially outward of the virtual line shown by the alternate long and two short dashes line in the drawing) of an outer peripheral surface 232 of each radially outer press-fitting portion 23 is formed as a sealing peripheral surface 232a that comes into close contact with the outer peripheral surface 42 of the corresponding radially outer sealing groove 4 to exert a sealing function. Another portion (portion axially inward of the virtual line shown by the alternate long and two short dashes line in the drawing) of the outer peripheral surface 232 of each radially outer press-fitting portion 23 is formed as a non-sealing peripheral surface 232b that exerts almost no sealing function. Accordingly, when being press-fitted into the radially outer sealing grooves 4 of the first and second piping blocks 11 and 12, the pair of radially outer press-fitting portions 23 of the gasket 2 function as secondary seals that prevent the fluid in the flow passage holes 13 and 14 from leaking to the outside.

### [Depression Portion]

In FIG. 9, an annular depression portion 6 for decreasing the thickness, in the radial direction (up-down direction in the drawing), of the main body portion 21 is formed on the outer peripheral surface of the main body portion 21 of the gasket 2. The depression portion 6 according to the present embodiment is formed by a concave curved surface formed so as to be deepest at the position of a center line C, in the axial direction, of the main body portion 21 in a cross-sectional view, and is formed across the boundary between the outer peripheral surface of the main body portion 21 and the outer peripheral surface 232 of each radially outer press-fitting portion 23. Specifically, the depression portion 6 is formed on the entirety, in the axial direction, of the outer peripheral surface of the main body portion 21 and an inner portion, in the axial direction, of the non-sealing peripheral surface 232b of the outer peripheral surface 232 of each radially outer press-fitting portion 23.

Accordingly, in the present embodiment, the main body portion 21 of the gasket 2 is formed such that the thickness thereof in the radial direction is small over the entirety in the axial direction, and the inner portion, in the axial direction, of each radially outer press-fitting portion 23 is formed such that the thickness in the radial direction thereof is small.

The depression portion 6 may be formed in an angular-recess shape in a cross-sectional view as shown in FIG. 10. Moreover, it is sufficient that the depression portion 6 is formed on at least a part of the outer peripheral surface of the main body portion 21. Furthermore, the depression portion 6 may be formed at a plurality of locations in the axial direction on the outer peripheral surface of the main body portion 21.

### Advantageous Effects

As described above, in the flow passage connector structure 1 according to the present embodiment, since the depression portion 6 is formed on the outer peripheral surface of the main body portion 21 which is a thick portion having a large thickness in the radial direction in the gasket 2 including the radially inner press-fitting portions 22 and the radially outer press-fitting portions 23, the thickness, in the radial direction, of the main body portion 21 can be decreased by the depression portion 6. Accordingly, the radially outer press-fitting portions 23 are easily deformed. Therefore, even when the roundness of each radially outer sealing groove 4 decreases during molding of the first and second piping blocks 11 and 12, the radially outer press-fitting portion 23 can be press-fitted into the radially outer sealing groove 4 by deforming the radially outer press-fitting portion 23 so as to match the shape of the radially outer sealing groove 4.

At this time, when the radially outer press-fitting portion 23 is deformed so as to fall down radially inward, if the depression portion 6 is not formed, tensile stress is generated at a center portion, in the axial direction, of the outer peripheral surface 232 of the radially outer press-fitting portion 23 (that is, the location corresponding to the depression portion 6), so that it becomes hard for the radially outer press-fitting portion 23 to fall down. However, in the present embodiment, since the depression portion 6 is formed on the center portion, in the axial direction, of the outer peripheral surface 232, it is easier for the radially outer press-fitting portion 23 to fall down radially inward.

Similarly, when the radially outer press-fitting portion 23 is deformed so as to fall down radially outward, if the depression portion 6 is not formed, compressive stress is generated at the center portion, in the axial direction, of the outer peripheral surface 232 of the radially outer press-fitting portion 23 (that is, the location corresponding to the depression portion 6), so that it becomes hard for the radially outer press-fitting portion 23 to fall down. However, in the present embodiment, since the depression portion 6 is formed on the center portion, in the axial direction, of the outer peripheral surface 232, it is easier for the radially outer press-fitting portion 23 to fall down radially outward.

Even when the depression portion 6 is formed on the inner peripheral surface of the main body portion 21, the thickness, in the radial direction, of the main body portion 21 can be decreased. However, in this case, the peripheral surface of the connection flow passage 24 formed by the inner peripheral surface of the main body portion 21 is not formed so as to be straight in the axial direction, so that there is a possibility that the fluid does not flow smoothly in the connection flow passage 24. On the other hand, since the depression portion 6 according to the present embodiment is formed on the outer peripheral surface of the main body portion 21, the flow of the fluid in the connection flow passage 24 is not obstructed.

Moreover, the depression portion 6 according to the present embodiment is formed on not only the outer peripheral surface of the main body portion 21 but also the non-sealing peripheral surface 232b of the outer peripheral surface 232 of each radially outer press-fitting portion 23. Accordingly, the thickness, in the radial direction, of each radially outer press-fitting portion 23 is decreased, and thus each radially outer press-fitting portion 23 is easier to deform. In addition, since the depression portion 6 is formed on the non-sealing peripheral surface 232b, which does not exert a sealing function, of the outer peripheral surface of each radially outer press-fitting portion 23, even when the depression portion 6 is formed on each radially outer press-fitting portion 23, the sealing performance of each radially outer press-fitting portion 23 does not deteriorate.

Moreover, since the depression portion 6 according to the present embodiment is formed by the concave curved surface, the thickness, in the radial direction, of the main body portion 21 can be gradually decreased. Thus, stress applied to the outer peripheral surface of the main body portion 21 when the radially outer press-fitting portion 23 is deformed can be distributed by the depression portion 6.

The embodiments disclosed in Chapter 2 are merely illustrative in all aspects and should be considered not restrictive. The scope of the present invention is defined by the scope of the claims rather than the meaning described above, and is intended to include meaning equivalent to the scope of the claims and all modifications within the scope.

For example, although the flow passage connector structure 1 used in the semiconductor field has been described as an example in the above embodiment, the field is not limited thereto, and the integrated block 1 may be used in the liquid crystal/organic EL field, the medical/pharmaceutical field, or the automotive field.

### REFERENCE SIGNS LIST

1 flow passage connector structure
2 gasket
3 radially inner sealing groove
4 radially outer sealing groove
6 depression portion
11 first piping block (fluid device)
11a end surface
12 second piping block (fluid device)
12a end surface
13 flow passage hole
14 flow passage hole
21 main body portion
22 radially inner press-fitting portion
23 radially outer press-fitting portion
42 outer peripheral surface of radially outer sealing groove
232 outer peripheral surface of radially outer press-fitting portion
232a sealing peripheral surface (one portion)
232b non-sealing peripheral surface (other portion)

1. A gasket comprising:
a pair of tubular press-fitting portions provided at both sides in an axial direction, for connecting flow passage holes formed in two fluid devices, respectively, and configured to be press-fitted into tubular sealing grooves formed, radially outward of the flow passage holes, on end surfaces of the fluid devices, respectively, wherein
a sealing peripheral surface configured to come into close contact with an outer peripheral surface of the sealing groove to exert a sealing function is formed in an outer peripheral surface of each of the press-fitting portions, and
a groove portion is formed on an outer peripheral surface of the gasket such that, in a state where either one press-fitting portion of the pair of press-fitting portions is press-fitted into the sealing groove of the fluid device, at least a part of the groove portion is open axially outward of the end surface of the fluid device.

2. The gasket according to claim 1, wherein a groove width, in the axial direction, of the groove portion is set within a range of a length in the axial direction between the sealing peripheral surfaces of the pair of press-fitting portions.

3. The gasket according to claim 1, wherein a groove depth, in a radial direction, of the groove portion is set such that a thickness, in the radial direction, of the gasket at a bottom surface of the groove portion is equal to or greater than a thickness, in the radial direction, of each press-fitting portion.

4. The gasket according to claim 1, wherein the groove portion is formed such that an entirety thereof is open between the end surfaces of the fluid devices in a state where the pair of press-fitting portions are press-fitted into the sealing grooves of the fluid devices, respectively.

5. A flow passage connector structure comprising:
the gasket according to claim 1 for connecting flow passage holes formed in two fluid devices, respectively; and
a pair of tubular sealing grooves which are formed, radially outward of the flow passage holes, on end surfaces of the fluid devices, respectively, and into which the respective press-fitting portions of the gasket are press-fitted.

6. A gasket for connecting flow passage holes formed in two fluid devices, respectively, the gasket comprising:
an annular main body portion;
a pair of radially inner press-fitting portions projecting axially outward from radially inner sides of both end portions, in an axial direction, of the main body portion, respectively, and configured to be press-fitted into radially inner sealing grooves formed at connection end portions of the flow passage holes of the fluid devices, respectively; and
a pair of cylindrical radially outer press-fitting portions projecting axially outward from radially outer sides of both end portions, in the axial direction, of the main body portion and configured to be respectively press-fitted into cylindrical radially outer sealing grooves formed, radially outward of the flow passage holes, on end surfaces at the connection end portion side of the fluid devices, wherein
an annular depression portion is formed on at least a part of an outer peripheral surface of the main body portion.

7. The gasket according to claim 6, wherein
a part of an outer peripheral surface of each of the radially outer press-fitting portions is formed as a sealing peripheral surface configured to come into close contact with an outer peripheral surface of the radially outer sealing groove to exert a sealing function, and
the depression portion is also formed on another part of the outer peripheral surface of each of the radially outer press-fitting portions.

8. The gasket according to claim 6, wherein the depression portion is formed by a concave curved surface.

9. A flow passage connector structure comprising:
the gasket according to claim 6 for connecting flow passage holes formed in two fluid devices, respectively;
a pair of radially inner sealing grooves which are formed at connection end portions of the flow passage holes of the fluid devices, respectively, and into which the respective radially inner press-fitting portions of the gasket are press-fitted; and
a pair of cylindrical radially outer sealing grooves which are formed, radially outward of the flow passage holes, on end surfaces at the connection end portion side of the fluid devices, respectively, and into which the respective radially outer press-fitting portions of the gasket are press-fitted.
